(19) United States
(12) Patent Application Publication
(10) Pub. No.: US 2011/0012041 A1
(43) Pub. Date: Jan. 20, 2011

(54) ELECTROMAGNETIC ACTUATOR FOR A PROPORTIONAL SOLENOID VALVE

(76) Inventors: Enzo De Santis, Fondi (IT); Fabrizio Marignetti, Napoll (IT); Giovanni Tomassi, Cassino (IT)

Correspondence Address: DICKSTEIN SHAPIRO LLP, 1825 EYE STREET NW, Washington, DC, 20006-5403, US

(21) Appl. No.: 12/811,313

(22) PCT Filed: Dec. 30, 2008
(86) PCT No.: PCT/IB2008/003648

§ 371 Date: Oct. 1, 2010

(30) Foreign Application Priority Data
Dec. 31, 2007 (IT) BO2007A000858

(51) Int. Cl. F16K 31/02

(52) U.S. Cl. 251/129.15

(57) ABSTRACT

An electromagnetic actuator for a proportional solenoid valve, which actuator has a fixed ferromagnetic core having a longitudinal axis, a plunger movable with respect to the fixed core along the axis between two stroke end positions, a spring for moving the plunger to the first stroke end position, an energizing winding to generate an electromagnetic induction field which produces a force against the bias of the spring and such that it moves the plunger to a equilibrium position between the stroke end positions, and wherein a surface portion of the plunger is increasingly facing a surface portion of the fixed core as the plunger approaches the second stroke end position, so that the electromagnetic induction field has an increasing number of force lines which close in the air gap between the fixed core and the plunger by crossing the first surface portion of the fixed core orthogonally to said axis.

### TECHNICAL FIELD

The present invention relates to an electromagnetic actuator for a proportional solenoid valve, i.e. a solenoid valve capable of generally performing precise kinematic trajectories according to an electric supply thereof.

### BACKGROUND ART

Electromagnetic actuators for solenoid valves of ON/OFF type are known, which actuators typically comprise a fixed ferromagnetic core, a movable ferromagnetic core, which is also known as a plunger and is movable with respect to the fixed core between two stroke end positions, an elastic element consisting, for example, of a helical spring adapted to move and normally maintain the valve in a first one of the stroke end positions, and an energizing winding integral with the fixed core adapted to generate, when electrically supplied, an electromagnetic induction field which produces an electromagnetic force tending to move the plunger towards the fixed core and such that it opposes the bias of the spring to move the plunger to the second stroke end position. The solenoid valve typically comprises a valve connected to the plunger by means of an actuator mechanism thereof.

In spite of the simple, thus cost-effective, structure of this type of electromagnetic actuator, continuously and linearly controlling the valve position by adjusting the electric current in the energizing winding is not allowed, and specifically defining stable equilibrium positions of the valve along its entire stroke is not allowed.

With this regard, FIG. 1 shows the typically hyperbolic trend of the electromagnetic force, indicated by Fem, generated by the actuator and the linear trend of the mechanical bias force, indicated by Fs, produced by the spring as a function of the displacement x of the plunger. Specifically, the electromagnetic force Fem is represented by a bundle of curves, each related to a respective intensity value of the electric current across the energizing winding. The curves of the electromagnetic force Fem intersect the line of the mechanical force Fs thus producing stable equilibrium positions, indicated by P, for only one portion of the plunger stroke. There are proportional solenoid valves in the prior art based on the adjustment of the contrast, specifically of the balance, between the generated electromagnetic force and the bias of an antagonist spring to produce a plurality of stable equilibrium positions along the entire valve stroke. These other solenoid valves have better linearity features but at cost of considerable mechanical complication.

By way of example, German patent application published under number DE-3817110-A1 describes a proportional solenoid valve capable of producing an electromagnetic force which has a sufficiently linear trend with respect to the displacement for a sufficiently wide excursion of the valve. The structure of such a solenoid valve is however more complex from the mechanical point of view, and is thus more expensive to be manufactured than the previously described solenoid valves, because it comprises, among others, two energizing windings and two antagonist springs.

Patents applications published under numbers US 2007/0236089-A1, EP-0199959-A2 and EP-1848013-A1 and United States patents published under numbers U.S. Pat. No. 6,556,027 and U.S. Pat. No. 5,014,747 disclose electromagnetic actuators according to the pre-characterizing portion of the independent claim 1.

### DISCLOSURE OF INVENTION

It is the object of the present invention to provide an electromagnetic actuator for a proportional solenoid valve, which actuator is free from the above-described drawbacks while being easy and cost-effective to be implemented.

In accordance with the present invention, an electromagnetic actuator for a proportional solenoid valve and a proportional solenoid valve are provided as defined in the appended claims.

### BRIEF DESCRIPTION OF THE DRAWINGS

The present invention will now be described with reference to the accompanying drawings, which show a non-limitative embodiment thereof, in which:

FIG. 1 shows the trend of the electromagnetic force generated by a known electromagnetic actuator of the prior art and by the mechanical force produced by an antagonist spring according to the displacement of the movable part of the actuator itself;

FIG. 2 shows a longitudinal section view of an electromagnetic actuator for a proportional solenoid valve, which actuator is made according to the present invention;

FIGS. 3 and 4 show a same part of the section view of FIG. 2 in which the electromagnetic actuator is in two different operating conditions, respectively;

FIG. 5 shows the trend of the axial forces acting in the electromagnetic actuator in FIG. 2; and

FIGS. 6 and 7 show the trend of the overall axial force generated by the electromagnetic actuator in FIG. 2.

### BEST MODE FOR CARRYING OUT THE INVENTION

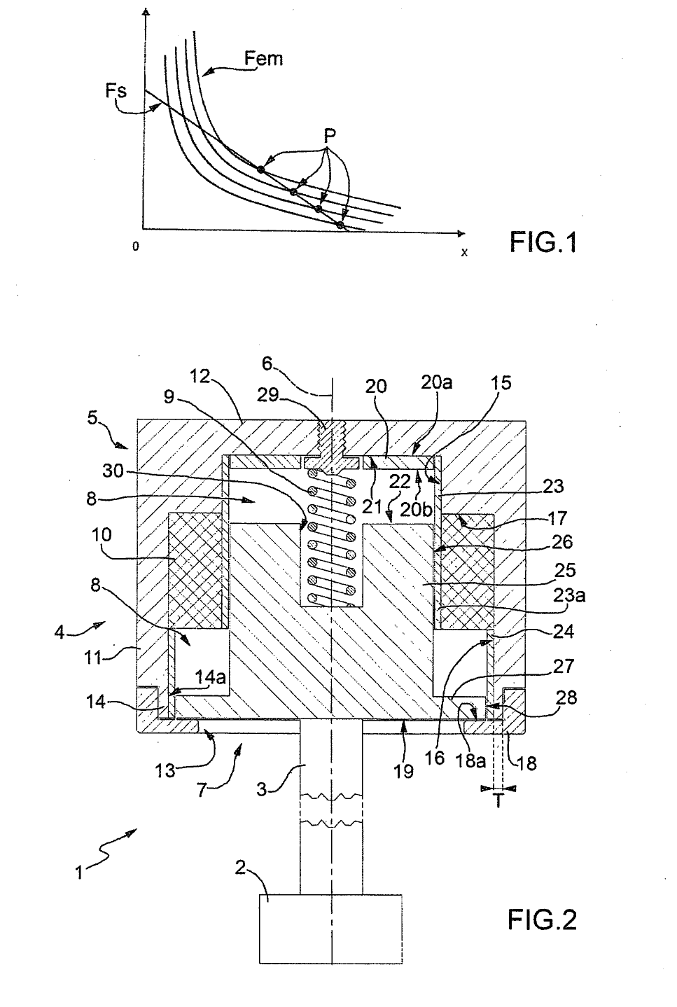

FIG. 1 shows the trend of the electromagnetic force Fem generated by an electromagnetic actuator of known type according to the prior art and the trend of the mechanical force Fs produced by an antagonist spring of the actuator as a function of the displacement x of the actuator plunger, the operation of which have already been described above and the limitations of which are overcome by the present invention.

In FIG. 2, numeral 1 generally indicates, according to a longitudinal section view, a proportional solenoid valve comprising a general valve 2, diagrammatically shown, adapted to adjust the flow rate or the pressure of a fluid either along or at the end of a fluid-dynamic circuit (not shown), an actuating mechanism of the valve consisting of an actuator rod 3 integral with the valve 2, for example, and an electromagnetic actuator 4 made according to the present invention and adapted to control the valve 2 by means of the rod 3.

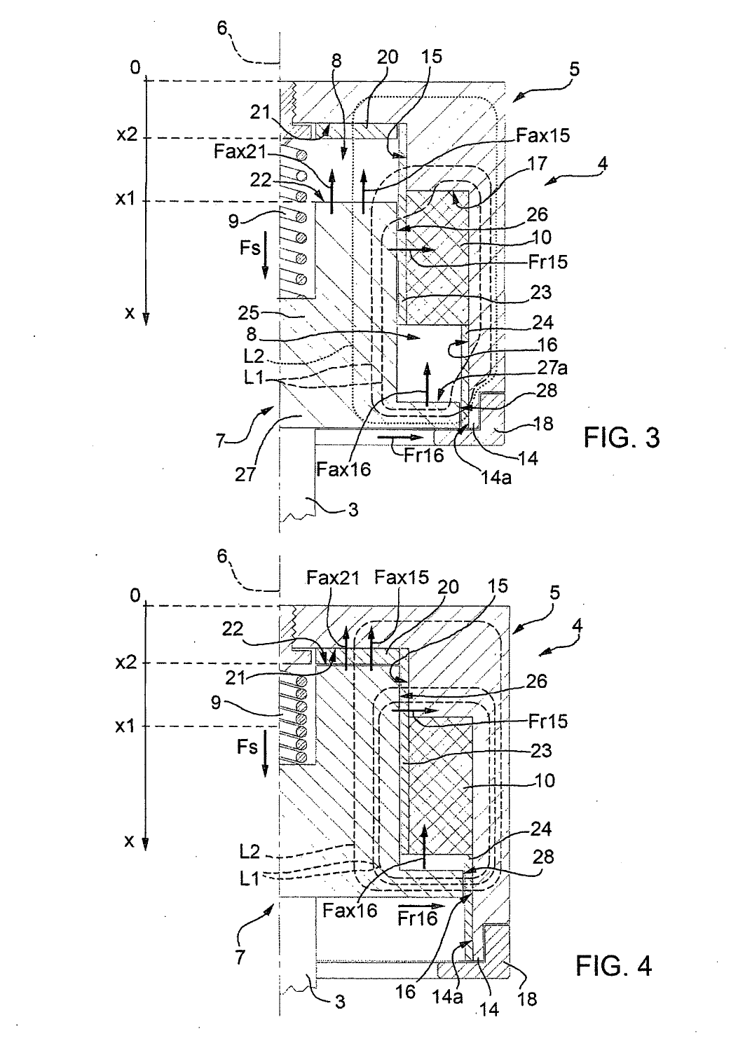

In the embodiment shown in FIG. 2, the actuator 4 has a circular symmetry with respect to a longitudinal axis. Specifically, the actuator 4 comprises a fixed ferromagnetic core, which is indicated by numeral 5, and consists of a cup-shaped body made of ferromagnetic material having a circular symmetry with respect to a longitudinal axis 6 thereof, and a movable plunger 7 with respect to the fixed core 5. The rod 3 of the valve 2 is made integral with the plunger 7 for transmitting the movement of the plunger 7 to the valve 2. The plunger 7 consists of a body made of ferromagnetic material body having a circular symmetry with respect to a longitudinal axis thereof (not shown) and is coaxially movable to the axis 6 so as to define an air gap 8 having a variable length, measured parallelly to axis 6. The fixed core 5, the plunger 7 and the air gap 8 define a magnetic circuit having a magnetic reluctance substantially defined by the air gap 8. Specifically, the plunger 7 is movable between a first stroke end position (FIG. 3), to which a maximum length of the air gap 8 corresponds (and thus a maximum magnetic reluctance value) and a second stroke end position (FIG. 4), to which a minimum length of the air gap 8 corresponds (and thus a minimum magnetic reluctance value).

Again with reference to FIG. 2, the actuator 4 comprises an elastic element consisting of a helical spring 9, for example, arranged in the air gap 8 in a coaxial position to the plunger 7 in order to exert a mechanical force for moving, and normally keeping the plunger 7 to/in the first stroke end position.

The actuator 4 comprises an energizing winding 10 of known type, e.g. a solenoid, which is integrally accommodated into the fixed core 5 so as to surround the plunger 7 in a substantially coaxial manner to the axis 6 in order to generate, when supplied by an electric current I, an electromagnetic induction field which produces an electromagnetic force acting on the plunger 7 so as to reduce the magnetic circuit reluctance. Therefore, the electromagnetic force is apt to move the plunger 7 to the second stroke end position, and specifically to counterbalance the bias of the spring 9 so as to move the plunger 7 to a equilibrium position located between the first and the second stroke end positions. The equilibrium position may be varied by modulating the intensity of the electric current I. The spring 9 thus ensures that the valve 2 works under safety conditions either by opening it (in case of normally open valve 2), or by closing it (in case of normally closed valve 2), when the energizing winding 10 is not electrically supplied.

More in detail, the fixed core 5 has a cylindrically shaped side wall 11 coaxial to the axis 6, a flat bottom wall 12 transversal, and specifically orthogonal, to the axis 6 and, on the opposite side of the bottom wall 12 along the axis 6, a circular opening 13 coaxial to the axis 6. The opening 13 is defined by an end portion 14 of the side wall 11 having a thickness T, measured on a plane perpendicular to the axis 6, smaller than that of the rest of the side wall 11 itself, and having a value such that the end portion 14 is magnetically saturated for a maximum value Imax of the electric current I and then, once saturated, substantially behaves as the air from the electromagnetic point of view.

The side wall 11 has an internal surface comprising a first cylindrical surface portion 15 coaxial to the axis 6, a second cylindrical surface portion 16, also coaxial to the axis 6 and having a larger diameter than that of the surface portion 15, and a third surface portion 17, which is shaped as a circular crown, is transversal and specifically orthogonal to the axis 6, and joins the surface portions 15 and 16 to each other to define an internal shoulder. Specifically, the surface portion 15 extends along the axis 6 from the bottom wall 12 to the surface portion 17, and the surface portion 16 extends along the axis 6 from the surface portion 17 to the end portion 14 excepted. The internal surface of the portion 14 is indicated by 14a.

A first ring 18 is fitted on the end portion 14 of the side wall 11, which ring 18 is made of magnetically inert material, i.e. of a substantially paramagnetic or diamagnetic material, such as, for example, aluminium, and has a U-shaped cross section to define a substantially flat resting surface 18a transversal to the axis 6. In FIG. 2, numeral 19 indicates a surface of the plunger 7 transversal to the axis 6 and facing outwards the fixed core 5. The first stroke end position of the plunger 7 is defined by the contact between the transversal surface 19 of the plunger 7 and the resting surface 18a.

According to a variant (not shown), the ring 18 is missing and the first stroke end position is defined by closing the valve 2, i.e. by the contact between the valve 2 and a seat or nozzle thereof.

A second ring 20, made of magnetically inert, elastic material, e.g. rubber, is accommodated into the fixed core 5. The ring 20 has two surfaces, indicated by numerals 20a and 20b, substantially parallel to each other and accommodated into the fixed core 5 in a coaxial position to the axis 6, with the surface 20a being in contact with an internal surface 21 of the bottom wall 12 transversal and specifically perpendicular to axis 6. In FIG. 2, numeral 22 indicates a surface of the plunger 7 transversal to the axis 6 and facing the internal surface 21 of the bottom wall 12. The second stroke end position of the plunger 7 is defined by the contact between the transversal surface 22 of the plunger 7 and the surface 20b of the ring 20. The interposition of the ring 20 between the internal surface 21 of the bottom wall 12 and the transversal surface 22 of the plunger 7 thus defines a minimum length of a part of the air gap 8 defined between the surfaces 21 and 22 themselves. The elasticity of the ring 20 allows to mitigate the stopping of the plunger 7 in the second stroke end position.

From the above, it is apparent that the plunger 7 remains inside the fixed core 5 in both stroke end positions, i.e. it never protrudes from the opening 13 in either stroke end positions.

The actuator 4 further comprises a first tubular element 23 inserted into the surface portion 15 in close contact with the same so as to be integral with the fixed core 5, and a second tubular element 24 fitted, coaxially to the first tubular element 23, into the end portion 14 and in the surface portion 16 in close contact with the same so as to be integral with the fixed core 5. The tubular element 23 extends to touch, with an end thereof, the internal surface 21 of the bottom wall 12 and protrudes from the opposite side, perpendicularly to the surface portion 17, with a portion 23a thereof facing the part of the surface portion 16. The energizing winding 10 is fitted on the portion 23a up to rest on the shoulder defined by the surface portion 17. The tubular element 24 extends along the entire end portion 14, thus totally covering it from the inside, and along at least one part of the surface portion 16 which is not covered by the energizing winding 10.

According to a variant (not shown), the tubular element 24 extends to cover the entire surface portion 16.

The tubular elements 23 and 24 act mainly as guides for the movement of the plunger 7 along the axis 6.

Specifically, the plunger 7 comprises a first cylindrical portion 25, which is adapted to slide into the tubular element 23 with an external side surface 26 thereof in contact with the tubular element 23 itself, and thus parallelly to the surface portion 15, and a second cylindrical portion 27, which is coaxial to the cylindrical portion 25, has a larger diameter than that of the cylindrical portion 25 and is adapted to slide into the tubular element 24 with a side surface 28 thereof being in contact with the tubular element 24 itself. The cylindrical portion 27 has a length measured along the axis 6 shorter than that of the cylindrical portion 25, and specifically substantially equal to the length measured parallelly to the axis 6, of the end portion 14. Accordingly, the side surface 28 and the end portion 14 substantially have the same length measured parallelly to the axis 6 so that the side surface 28 is adapted to fully face the internal surface 14a of the end portion 14 only when the plunger 7 is in the first stroke end position. The transversal surface 19 corresponds to the lower surface of the cylindrical portion 27 and the transversal surface 22 corresponds the upper surface of the cylindrical portion 25.

Each of the tubular elements 23 and 24 is made of magnetically inert material, i.e. paramagnetic or diamagnetic material, to avoid anomalous closures of the electromagnetic flow between the corresponding surface portion 15, 16 of the fixed core 5 and the corresponding side surface 26, 28 of the plunger 7, and having a low friction coefficient with the side surface 26, 28 of the plunger 7. For example, each tubular element 23, 34 may be made of either Teflon or brass.

The spring 9 is arranged with an end thereof mounted on the bottom wall 12 of the fixed core 5 by means of an adjustment screw 29 screwed onto the bottom wall 12 itself, and with the opposite end inserted into a hole 30 made in the cylindrical portion 25 of the plunger 7 on the side of the transversal surface 22. The spring 9 thus arranged is adapted to exert a mechanical force which presses the plunger 7 towards the first stroke end position.

The operation of the actuator 4 is described hereinafter with particular reference to FIGS. 3 and 4, where the actuator 4 is shown with the plunger 7 in the first stroke end position and in the second stroke end position, respectively, and in which the corresponding elements are indicated by the same numbers of FIG. 2. For greater simplicity and clarity, the FIGS. 3 and 4 show one half of the section view of the FIG. 2, with respect to axis 6, and depict the displacement x of the transversal surface 22 of the plunger 7 parallelly to axis 6. At the first and second stroke end positions, the displacement x takes respective values indicated by x1 and x2, respectively.

With reference to FIG. 3, in which the plunger 7 is in the first stroke end position in virtue of the action of the spring 9 which exerts a direct mechanical force parallelly to the axis 6 in the direction indicated by the arrow Fs, an electromagnetic induction field, which has force lines crossing several portions of the internal surface of the fixed core 5, is generated soon as the energizing winding 10 is electrically supplied.

Specifically, such force lines comprise first force lines, which cross the surface portion 15 and, from the side opposite to the energizing winding 10, the surface portion 16 and the internal surface 14a of the end portion 14 (only two of which are shown and indicated by L1 in FIG. 3); and second force lines, which cross the internal surface 21 of the bottom wall 12 and, from the opposite side of the energizing winding 10, the internal surface 14a (only one of which is shown and indicated with L2 in FIG. 3). The rings 18 and 20 and the tubular elements 23 and 24, being magnetically inert, substantially behave as the air in the air gap 8. The magnetic behaviour of the end portion 14 instead differs according to the intensity of the electric current I. FIG. 3 shows the situation for high values of electric current I, in which the end portion 14 is magnetically saturated so that some force lines L1 and L2, and specifically the innermost force lines L1, tend to close in the air gap 8 over the cylindrical portion 27, i.e. through an annular surface portion 27a of the cylindrical portion 27 transversal to the axis 6 and facing the surface portion 17 of the fixed core 5, rather than at the end portion 14.

Again with reference to FIG. 3, the force lines L1 are not orthogonal to the surface portions 15 and 16 and to the internal surface 14a of the end portion 14. This means that the surface portions 15 and 16 are associated with respective axial components Fax15 and Fax16 and respective radial components Fr15 and Fr16 of the electromagnetic force. The axial components Fax15 and Fax16 push the plunger 7 parallelly to the axis 6 to the opposite direction to that of the mechanical force Fs, while the radial components Fr15 and Fr16 are directed perpendicularly to the axis 6 and produce a zero resulting force due to the circular symmetry of the fixed core 5 and the plunger 7. On the other hand, force lines L2 are substantially orthogonal to the internal surface 21 of the bottom wall 12 of the fixed core 5. Therefore, the internal surface 21 is associated with an axial component Fax21 of the electromagnetic force. Due to the high length of the air gap 8 between the internal surface 21 of the fixed core 5 and the transversal surface 22 of the plunger 7, the axial component Fax21 has however a highly lower intensity than the axial components Fax15 and Fax16, thus only marginally contributing to a resulting axial force. For this reason, the force line L2 is shown in FIG. 3 by a dotted line instead of by a dashed line as the force lines L1.

As that the plunger 7 approaches the second stroke end position, the side surface 26 of the plunger 7 increasingly faces the surface portion 15 inside the fixed core 5. Similarly, the side surface 28 of the plunger 7 increasingly faces the surface portion 16 inside the fixed core 5 as the plunger 7 approaches the second stroke end position. Accordingly, the number of force lines L1 which are orthogonally oriented to the surface portions 15 and 16 increases as the plunger 7 approaches the second stroke end position. In other words, as the plunger 7 approaches the second stroke end position, the radial components Fr15 and Fr16 increase in intensity and, consequently, the axial components Fax15 and Fax16 decrease in intensity. On the contrary, the axial component Fax21 increases in intensity as the plunger 7 approaches the second stroke end position, because the length of the air gap 8 between the transversal surface 22 of the plunger 7 and the internal surface 21 of the fixed core 5 is progressively reduced.

It is worth noting that the tubular element 23 is interposed between the surfaces 26 and 15 and the tubular element 24 is interposed between the surfaces 28 and 16. However, the presence of the tubular elements 23 and 24 is substantially negligible from the electromagnetic point of view in virtue of the material used for making the tubular elements 23 and 24. Therefore the increasing facing between the surfaces 26 and 15 and between the surfaces 28 and 16 is to intended effective from the electromagnetic point of view.

With reference to FIG. 4, in which the plunger 7 is in the second stroke end position, substantially all force lines L1 are orthogonal to both surface portions 15 and 16. At the surface portion 16, the condition of orthogonality of all force lines L1 is reached already before the plunger 7 reaches the second stroke end position due to the reduced extension, measured along the axis 6, of the surface 28. The force lines L2 are substantially orthogonal to the internal surface 21 of the bottom wall 12 and, on the opposite side of the winding 10, to the surface portion 16, and are shown by a solid line because the contribution of the corresponding axial component Fax21 is no longer marginal and becomes comparable to that of the axial components Fax15 and Fax16.

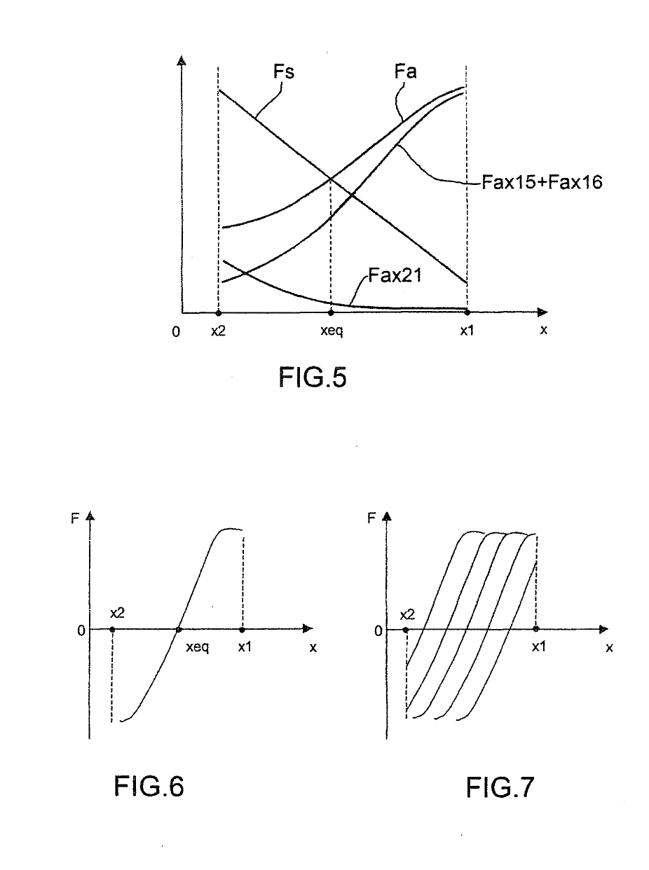

FIG. 5 shows an example of the trend of the axial components Fax15 and Fax16 sum, indicated by Fax15+Fax16, of the axial component Fax21 and of the mechanical force Fs as a function of the displacement x. The axial components Fax15, Fax16 and Fax21 are obtained for a given value of the electric current I. By adding up the axial components Fax15, Fax16 and Fax21, an axial resultant, indicated by Fa in FIG. 5, is obtained which has a monotonous trend decreasing with the movement of the plunger 7 from the first (x=x1) to the second (x=x2) stroke end positions, and thus which has an opposite slope with respect to that of the straight line of the mechanical force Fs. In this manner, the intersection between the curve of the resulting force Fa and the line of the mechanical force Fs always produces a stable equilibrium position (x=xeq) for any values of the electric current I.

It is worth noting that for low values of the electric current I, the end portion 14 is not saturated and, unlike that shown in FIG. 3, the force lines L1 and L2 tend to be arranged so as to cross the end portion 14 in a substantially orthogonal manner with respect to the internal surface 14a, thus causing a reduction of the axial component Fax16 when the plunger 7 is close to the first stroke end position.

Furthermore, it is worth noting that the specific trend of the axial resultant Fa is not only due to the introduction of axial components Fax15, Fax16, which quickly decrease with the decrease of the displacement x, but is also due to the strong limitation of the increase of the axial component Fax21. The latter effect is obtained in virtue of the fact that the force lines L1 are diverted towards the surface portion 15, and thus towards the side wall 11, instead of towards the bottom wall 12 of the fixed core 5, but also by appropriately dimensioning the thickness of the ring 20, which acts as a spacing element between the bottom wall 12 of the fixed core 5 and the plunger 7, thus defining the minimum length of the air gap 8 between the surface 21 and 22, and thus a minimum magnetic reluctance value which needs to be sufficiently high to limit the axial component Fax21 to a maximum value in the second stroke end position. In other words, such a maximum value of the axial component Fax21 is defined by the minimum length of the air gap 8 between the surfaces 21 and 22, and therefore by the thickness of the ring 20.

FIG. 6 shows the trend of an overall force F, obtained by the algebraic sum of the mechanical force Fs with the axial resultant Fa for a given value of electric current I, as a function of the displacement x. As apparent, the trend of the overall force F is strongly linear as the displacement x of the plunger 7 varies between the two stroke end positions. The curve of the overall force F moves parallelly to itself as the electric current I varies, thus describing a family of curves shown in FIG. 7.

It is worth emphasizing the importance of the correct dimensioning of the thickness T of the end portion 14 in order to obtain the desired linear behaviour of the actuator 4. Indeed, if there were no end portion 14, the reluctance of the magnetic circuit would not be as high, and the axial component Fax15 would have lower values along the initial segment of the stroke of the plunger 7. On the contrary, if the thickness T were equal to the thickness of the rest of the side surface 11, and thus the surface portion 16 extended to the resting surface 18a, the axial component Fax16 would not exist because the force lines L1 and L2 would always cross the surface portion 16 orthogonally thereto.

According to a further embodiment, the actuator 4 has a symmetry with respect to a plane comprising the axis 6, and figures from 2 to 4 show the actuator 4 according to a section view perpendicular to said symmetry plane.

The main advantage of the above-described electromagnetic actuator 4 is, therefore, to allow the implementation of a proportional solenoid valve capable of producing a strongly linear overall force F as the displacement x of the plunger 7, and thus of the valve 2, varies.

Furthermore, the actuator 4 has an extremely simple, compact structure. Indeed, the actuator 4 is formed by a few components and the plunger 7 always remains inside the fixed core 5 in both stroke end positions. This implies considerably lower manufacturing costs and a greater reliability as compared to the known solenoid valves of comparable performance.

1. An electromagnetic actuator for a proportional solenoid valve (1); the actuator (4) comprising a fixed core (5) made of ferromagnetic material having a longitudinal axis (6) and a first surface portion (21) transversal to said axis (6), a plunger (7) made of ferromagnetic material which is movable with respect to the fixed core (5) along said axis (6) between first and second stroke end positions (x1, x2) so as to define an air gap (8) having a variable length measured along said axis (6), elastic means (9) for moving and normally keeping the plunger (7) to/in the first stroke end position (x1), and electromagnetic energizing means (10) to generate, when electrically supplied, an electromagnetic induction field which produces an electromagnetic force such that the mechanical force (Fs) of the elastic means (9) is counterbalanced so as to move the plunger (7) to a equilibrium position (xeq) between said stroke end positions (x1, x2); and being characterized in that the fixed core (5) has a second surface portion (15, 16) and the plunger (7) has a third surface portion (26, 28) arranged to increasingly face the second surface portion (15, 16) as the plunger (7) moves from the first stroke end position (x1) to the second stroke end position (x2) in such a way that:
the electromagnetic induction field has an increasing number of first force lines (L1) which close in the air gap (8) by crossing the second surface portion (15, 16) orthogonally to said axis (6) and second force lines (L2) which close in the air gap (8) by crossing the first surface portion (21) parallelly to the axis (6);
the electromagnetic force has a first axial component (Fax15, Fax16) produced by the first force lines (L1) having a decreasing intensity and a second axial component (Fax21) produced by the second force lines (L2) having a increasing intensity; and
the intensity of the first axial component (Fax15, Fax16) is higher than the intensity of the second axial component (Fax21) for the majority of the stroke of the plunger (7), so that the sum of the first and second axial components (Fax15, Fax16, Fax21) produces an axial resultant (Fa) which has a decreasing intensity and has an opposite slope with respect to that of said mechanical force (Fs).

2. An electromagnetic actuator according to claim 1, wherein said second surface portion (15, 16) and said third surface portion (26, 28) are parallel to said axis (6).

3. An electromagnetic actuator according to claim 1, wherein said fixed core comprises a cup-shaped body (5) made of ferromagnetic material; said plunger (7) remaining inside the cup-shaped body (5) in both said stroke end positions (x1, x2).

4. An electromagnetic actuator according to claim 3, wherein said second surface portion (15, 16) is an internal surface portion of the fixed core (5) and said third surface portion (26, 28) is an external surface portion of the plunger (7).

5. An electromagnetic actuator according to claim 3, wherein said electromagnetic energizing means comprise an energizing winding (10) integrally accommodated into the cup-shaped body (5).

6. An electromagnetic actuator according to claim 1, wherein said electromagnetic energizing means comprise an energizing winding (10) arranged in a coaxial position with respect to said axis (6) and so as to surround a portion (25) of said plunger (7).

7. An electromagnetic actuator according to claim 1, wherein said fixed core (5) has a circular symmetry shape with respect to said axis (6); said plunger (7) having a circular symmetry shape and being movable in a coaxial manner to the fixed core (5).

8. An electromagnetic actuator according to claim 1, the actuator (4) having a symmetry with respect to a plane including said axis (6).

9. An electromagnetic actuator according to claim 1, comprising guiding means (23, 24) interposed between said second surface portion (15, 16) and said third surface portion (26, 28) to allow the plunger (7) to slide along said axis (6).

10. An electromagnetic actuator according to claim 1, wherein said second surface portion (15, 16) comprises a fourth surface portion (15) having a cylindrical shape; said third surface portion (26, 28) comprising a fifth surface portion (26), which has a cylindrical shape and is arranged so as to increasingly face the fourth surface portion (15) as the plunger (7) approaches the second stroke end position (x2).

11. An electromagnetic actuator according to claim 1, wherein said fixed core (5), plunger (7) and air gap (8) define a magnetic circuit having a magnetic reluctance which varies with the position of the plunger (7); a maximum magnetic reluctance value corresponding to said first stroke end position (x1) and a minimum magnetic reluctance value corresponding to said second stroke end position (x2).

12. An electromagnetic actuator according to claim 3, wherein said electromagnetic energizing means (10) are supplied with an electric current (I) and said cup-shaped body (5) comprise a side wall (11) having an end portion (14), which defines an opening (13) of the cup-shaped body (5) and has a thickness (T), measured on a perpendicular plane to said axis (6), smaller than that of the remaining side wall (11), so that the end portion (14) itself is magnetically saturated for a maximum value (Imax) of the electric current (I).

13. An electromagnetic actuator according to claim 12, wherein said plunger (7) comprises a cylindrical portion (27) having an annular surface portion (27a) transversal to said axis (6) and said third surface portion (26, 28) comprises a side surface portion (28) of said cylindrical portion (27); the side surface portion (28) and said end portion (14) substantially having a same length measured parallelly to the axis (6), so that when the plunger (7) is in said first stroke end position (x1), the side surface portion (28) is adapted to completely face an internal surface (14a) of the end portion (14), and so that some of said first force lines (L1) close in said air gap (8) by crossing the internal surface (14a) and other of the first force lines (L1) close in the air gap (8) by crossing the annular surface portion (27a) for high values of said electric current (I).

14. An electromagnetic actuator according to claim 1, wherein said plunger (7) has an eighth surface portion (22) transversal to said axis (6) and facing said first surface portion (21); the actuator (4) comprising a spacer element (20), which is interposed between the first (21) and the eighth (22) surface portion in contact with the first surface portion (21); said second stroke end position (x2) being defined by the contact between the eighth surface portion (22) and the spacer element (20), so that the latter defines a minimum length of a portion of said air gap (8) comprised between the first (21) and the eighth (22) surface portion; said second axial component (Fax21) being limited, at the second stroke end position (x2), to a maximum value defined according to said minimum length.

15. An electromagnetic actuator according to claim 14, wherein said spacer element (20) is made of a magnetically inert material.

16. A proportional solenoid valve comprising a valve (2), actuating means (3) of the valve (2) and an electromagnetic actuator (4), which comprises a fixed core (5) made of ferromagnetic material and a plunger (7) made of ferromagnetic material which is movable with respect to the fixed core (5) and connected with the actuating means (3) to transmit the movement to the valve (2); the actuator (4) being characterized in that it is of the type claimed in claim 1.

17. An electromagnetic actuator according to claim 10, wherein said second surface portion (15, 16) comprises a sixth surface portion (16), which has a cylindrical shape with a diameter larger than that of said fourth surface portion (15) and is coaxial to the latter; said third surface portion (26, 28) comprising a seventh surface portion (28), which has a cylindrical shape with a diameter larger than that of said fifth surface portion (26), is coaxial to the latter and is arranged so as to increasingly face the sixth surface portion (16) as the plunger (7) approaches the second stroke end position (x2).
